(19) United States
(12) Patent Application Publication
(10) Pub. No.: US 2014/0095068 A1
(43) Pub. Date: Apr. 3, 2014

(54) METHOD AND SYSTEM FOR REDUCING TRAFFIC CONGESTION

(71) Applicant: XEROX CORPORATION, Norwalk, CT (US)

(72) Inventors: Rakesh Suresh Kulkarni, Webster, NY (US); Guangyu Zou, Webster, NY (US)

(73) Assignee: XEROX CORPORATION, Norwalk, CT (US)

(21) Appl. No.: 13/629,984

(22) Filed: Sep. 28, 2012

(51) Int. Cl. G01C 21/20

(52) U.S. Cl. 701/487; 701/538

(57) ABSTRACT

A point-based method, system and processor-readable medium for reducing traffic congestion. A license plate number associated with a vehicle can be captured utilizing an image capturing unit and/or a GPS (Global Positioning System) enabled mobile communication device to store/deduct points with respect to a user account on a point storage server. The points can be stored in a user account based on a dynamic policy if a user selects a sub-optimal path (e.g., general-purpose lane or a far-away parking spot) and the level of urgency related to travel is low to reduce congestion. The points can be deducted later if the user decides to take an optimal path (e.g., HOT lane or a near-center parking spot). The points on each path can be dynamically set based on time of day to maintain traffic flow at an optimal level.

### TECHNICAL FIELD

Embodiments are generally related to traffic management methods and systems. Embodiments are also related to methods and systems for reducing traffic congestion.

### BACKGROUND OF THE INVENTION

Traffic congestion is a condition on a road network that occurs as use increases, and is characterized by slower speeds, longer trip times, and increased vehicular queueing. Several travel demand management techniques have been attempted to alleviate traffic congestion. For example, HOT lanes (High occupancy/toll lanes) can be employed to encourage people to share rides, and thus decrease the amount of vehicles on the roads.

HOT lanes can be implemented in the context of a road pricing scheme that provides motorists in a vehicle access to a HOV (High Occupancy Vehicle) lane. Sometimes entire roads can be designated for the use of HOVs. Tolls can be collected either by a manned toll booth, automatic number plate recognition, or an electronic toll collection system. Typically, these tolls increase as traffic density and congestion within the tolled lanes increases, a policy known as congestion pricing. The majority of prior art pricing scheme do not take into account the social aspect as well as penalizes users inequitably.

Based on the foregoing, it is believed that a need exists for an improved point-based system and method for reducing traffic congestion, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved traffic congestion management methods and systems.

It is another aspect of the disclosed embodiments to provide for an improved point-based system and method for reducing traffic congestion.

The aforementioned aspects and other objectives and advantages can now be achieved as described herein. A point-based system and method for reducing traffic congestion is disclosed herein. A license plate number associated with a vehicle can be captured utilizing an image capturing unit and/or a GPS (Global Positioning System) enabled mobile communication device to store/deduct points with respect to a user account on a point storage server. The points can be stored to the user account based on a dynamic policy if a user chooses a sub-optimal path (e.g., general-purpose lane or a far-away parking spot) and the level of urgency related to travel is low to reduce congestion. The points can be deducted later if the user decides to take an optimal path (e.g., HOT lane or a near-center parking spot) based on the dynamic policy. The points on each path can be dynamically set based on time of day to have the traffic flow at a right level. Such an approach provides an incentive for the user to make a better choice and also indirectly reduces congestion for other users.

In one implementation, the image capturing unit, for example, a scanner detects the license plate number when the user approaches a toll gate on a HOT lane so that the corresponding points can be deducted from the users account. In another implementation, the mobile communication device captures the license plate number and transmits such information to the server. The points can be granted to the user utilizing the GPS embedded in the mobile communication device if the user travels on the general purpose lane and/or via a transit. Information such as, for example, start and end of route can be manually entered by the user. The mobile communication device can also display a barcode that is unique to identify the user.

The user can earn the points if the vehicle is parked in a far-away parking spot and the points can be deducted if the vehicle is parked in a near-center parking spot. If the average speed of the managed lane is lower than a target, more points are required to access the managed lane and more points can be granted if the user chooses the general purpose lane. Similarly, if the near-center parking spot is close to full then more points can be required. Such an approach reduces the flow of currency and makes easier for the user to utilize multiple modes of transport.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including a traffic congestion reducing module, an operating system, and a user interface, in accordance with the disclosed embodiments;

FIG. 3 illustrates a block diagram of a traffic congestion reducing system, in accordance with the disclosed embodiments;

FIG. 4 illustrates a high level flow chart of operations illustrating logical operational steps of a method for reducing traffic congestion, in accordance with the disclosed embodiments; and

FIG. 5 illustrates a high level flow chart of operations illustrating logical operational steps of a method for configuring a dynamic policy, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein: rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

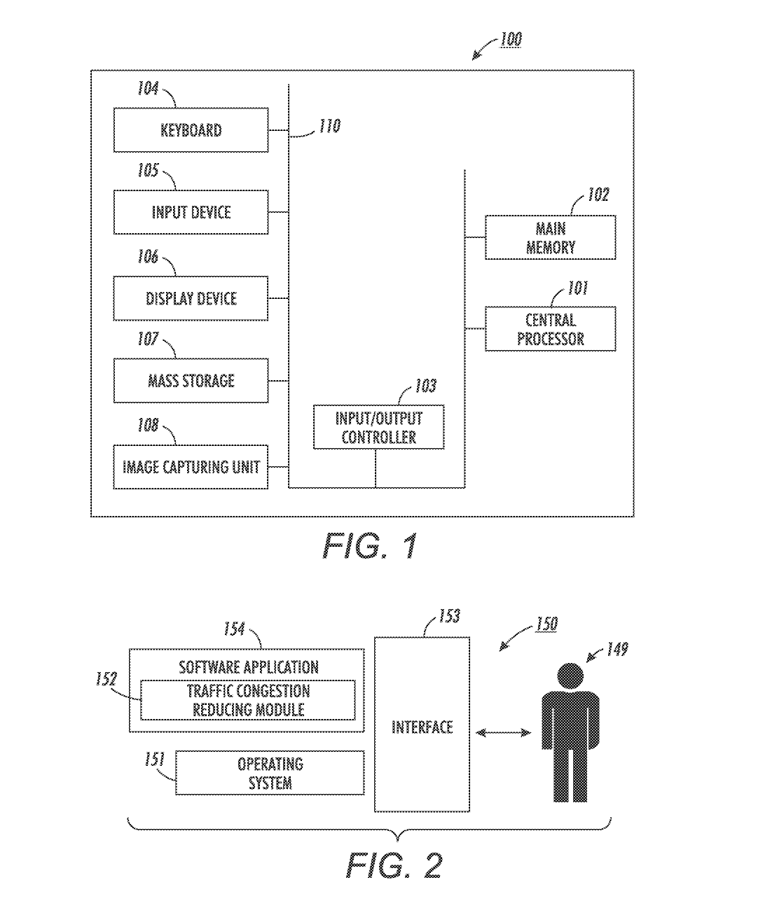

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a system bus 110, a central processor 101, a main memory 102, an input/output controller 103, a keyboard 104, an input device 105 (e.g., a pointing device such as a mouse, track ball, and pen device, etc.), a display device 106, a mass storage 107 (e.g., a hard disk), and an image capturing unit 108. In some embodiments, for example, a USB peripheral connection (not shown in FIG. 1) and/or other hardware components may also be in electrical communication with the system bus 110 and components thereof. As illustrated, the various components of data-processing system 100 can communicate electronically through the system bus 110 or a similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

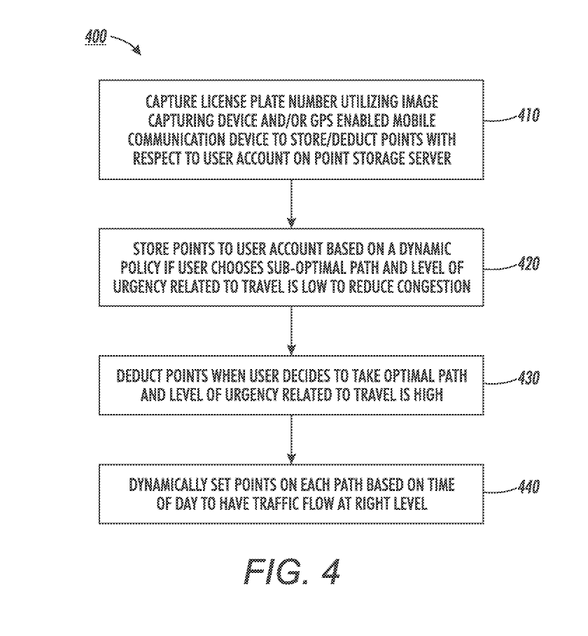

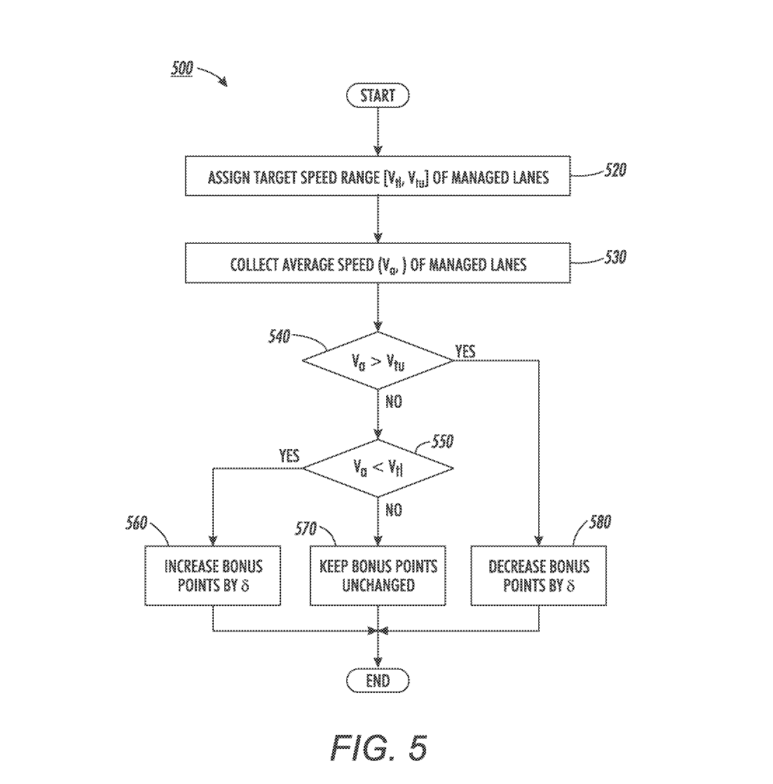

The interface 153, which is preferably a graphical user interface (GUI), also serves to display results, whereupon the user may supply additional inputs or terminate the session. In an embodiment, operating system 151 and interface 153 can be implemented in the context of a “Windows” system. It can be appreciated, of course, that other types of systems are possible. For example, rather than a traditional “Windows” system, other operating systems such as, for example, Linux may also be employed with respect to operating system 151 and interface 153. The software application 154 can include a traffic congestion reducing module 152 for reducing traffic congestion. Software application 154, on the other hand, can include instructions such as the various operations described herein with respect to the various components and modules described herein such as, for example, the methods 400 and 500 depicted in FIGS. 4-5.

FIGS. 1-2 are thus intended as examples and not as architectural limitations of the disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, and the like.

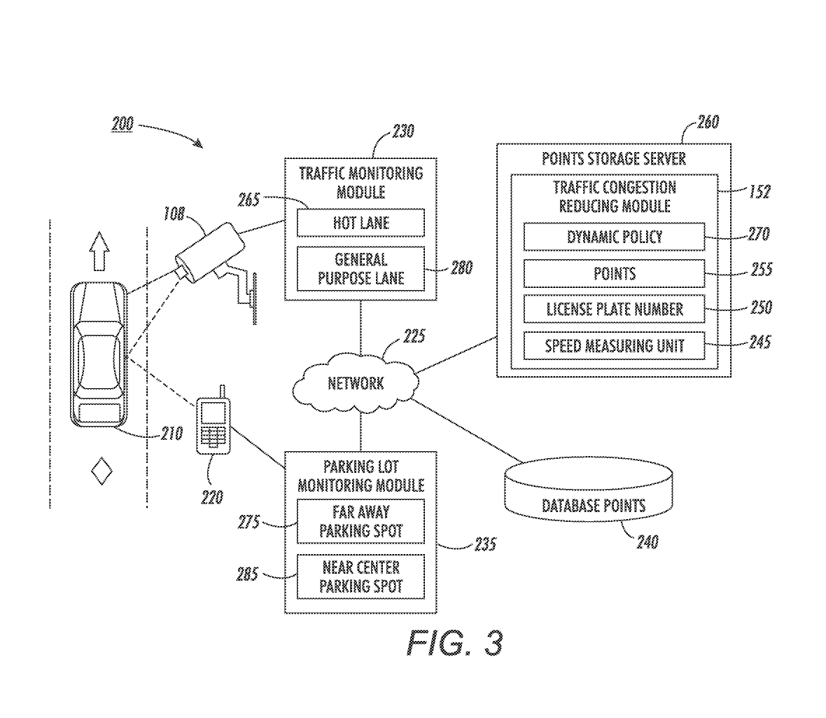

FIG. 3 illustrates a block diagram of a traffic congestion reducing system 200, in accordance with the disclosed embodiments. Note that in FIGS. 1-5, identical or similar blocks are generally indicated by identical reference numerals. The traffic congestion reducing system 200 generally includes an image capturing unit 108 (e.g., scanner) and/or a mobile communication device 220 for capturing an image of a vehicle 210 within an effective field of view. The image capturing unit 108 (e.g., camera) and/or a mobile communication device 220 can be operatively connected to a point storage server 260 via a network 225. The image capturing unit 108 may include built-in integrated functions such as image processing, data formatting, and data compression functions.

Note that the network 225 may employ any network topology, transmission medium, or network protocol. The network 225 may include connections such as wire, wireless communication links, or fiber optic cables. Network 225 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages.

The point storage server 260 can be configured to include the traffic congestion reducing module 152. The image capturing unit 108 and/or the GPS enabled mobile communication device 220 can, for example, capture a license plate number from a vehicle such as vehicle 210. The traffic congestion reducing module 152 store/deduct points 255 with respect to a user account on the point storage server 260. The traffic congestion reducing module 152 stores the points 255 to the user account based on a dynamic policy 270 if a user chooses a sub-optimal path and the level of urgency related to travel is low to reduce congestion. Note that the sub-optimal path can be, for example, a general purpose lane 280 or a far-away parking spot 275.

The points 255 can be employed later if the user decides to select an optimal path of travel. Note that such an optimal path can be, for example, a HOT lane 265 or a near-center parking spot 285. HOT lanes require single-occupant vehicles to pay a to that varies based on demand, called congestion pricing. The tolls change throughout the day according to real-time traffic conditions, which is intended to manage the number of vehicles in the lanes to keep them less congested. The traffic congestion reducing module 152 dynamically set the points 255 on each path based on a time of day to have the traffic flow at a right level. The points can be stored in a database 240.

A traffic monitoring module 230 utilizes the image capturing unit 108, for example, a scanner to detect the license plate number 250 when the user approaches the toll gate on the HOT lane 265 so that the corresponding points 255 can be deducted from the users account. A parking lot monitoring module 235 can employ the mobile communication device 220 to capture, for example, a license plate number (e.g., license plate number 250) from a vehicle and transmit such information to the server 260.

The points 255 can be granted to the user utilizing GPS embedded in the mobile communication device 220 if the individual travels on the general purpose lane 280 and/or via a transit. It can be appreciated that the traffic monitoring module 230 and the parking lot monitoring module 235 can be implemented as software modules. Information such as, for example, start and end of route can be manually entered by the user. The mobile communication device 220 can also display a barcode that is unique to identify the user if the access point is unable to scan the plate number 250.

The traffic congestion reducing module 152 can grant points 255 to the user if the vehicle 210 is parked in the far-away parking spot 275 and can deduct points 255 if the vehicle 210 is parked in the near-center parking spot 285. A speed measuring unit 245 can calculate the average speed of the managed lane. If the average speed of the managed lane is higher than a target, more points 255 can be required to access the managed lane and less points 255 can be granted if the user takes the general-purpose lane 280. Similarly, if the near-center parking spot 285 is close to full, then more points 255 can be required.

For example, A wants to travel from point X to Y in peak hour. Consider four possible ways (a, b, c, d) to reach Y from X: a represents the path (e.g., HOT lane) that is the fastest and most reliable and requires 10,000 points; b represents the path (e.g., transit) that may be slightly inconvenient but earns 1500 points; c represents the path (e.g., internal roads) that has intersections with signals and the user can earn 1000 points; and d is the path of using the general purpose (GP) lanes earning 500 points. The user can choose the optimal path at that point in time. So if the user has no time constraints, he/she may choose b or c or d; if there is a need to go fast, he/she may choose a. Similarly, in parking, if the user has to park in a densely populated place, the user has two choices. The user can earn points if he parks far-away from the place and the points can proportionately increase further away the user goes. Also, closer to the dense location, the points to be spent can be higher.

FIG. 4 illustrates a high level flow chart of operations illustrating logical operational steps of a method 400 for reducing traffic congestion by providing bonus points 255, in accordance with the disclosed embodiments. It can be appreciated that the logical operational steps shown in FIGS. 4-5 can be implemented or provided via, for example, a module such as module 154 shown in FIG. 2 and can be processed via a processor such as, for example, the processor 101 shown in FIG. 1. Initially, as indicated at block 410, the license plate number 250 with respect to the vehicle 210 can be captured utilizing an image capturing unit 108 and/or a GPS enabled mobile communication device 220 to store/deduct points 255 with respect to a user account on a point storage server.

The points 255 can be stored to the user account based on the dynamic policy 270 if a user chooses a sub-optimal path and the level of urgency related to travel is low to reduce congestion, as shown at block 420. The points 255 can be used later when the user decides to take an optimal path, as depicted at block 430. The points 255 on each path can be dynamically set based on a time of day to have the traffic flow at a right level, as indicated at block 440.

FIG. 5 illustrates a high level flow chart of operations illustrating logical operational steps of a method 500 for configuring the dynamic policy 270, in accordance with the disclosed embodiments. The target speed range of the managed lane [Vₜₗ, Vₜᵤ] can be assigned, as shown at block 520. The average speed of the managed lane Vₐ can be collected, as indicated at block 530. A determination can be made whether the average speed of the managed lane Vₐ is higher than the upper target speed range Vₜᵤ of the managed lane, as indicated at block 540. If the average speed of the managed lane Vₐ is higher than the upper target speed range Vₜᵤ of the managed lane, the bonus point can be decreased by δ, as shown at block 580.

Otherwise, another determination can be made whether the average speed of the managed lane Vₐ is higher than the lower target speed range Vₜₗ of the managed lane, as indicated at block 550. If the average speed of the managed lane Vₐ is lower than the lower target speed range Vₜₗ of the managed lane, the bonus point can be increased by δ, as depicted at block 560. Otherwise, the bonus points 255 can be kept unchanged, as shown at block 570. The system 200 provides incentive for the user to make a choice and also indirectly reduces congestion for other users. The system 200 reduces the flow of currency and makes easier for user traveler to use multiple modes of transport.

Based on the foregoing, it can be appreciated that a number of embodiments, preferred and alternative, are disclosed herein. For example, in one embodiment a method for reducing traffic congestion can be implemented. Such a method can include, for example, the steps or logical operations of capturing an identifier associated with a vehicle utilizing an image capturing unit that stores and/or deducts at least one point with respect to a user account, storing the at least one point in the user account based on a dynamic policy if a user chooses a sub-optimal path of travel and a level of urgency related to the travel is low, and deducting the at least one point if the user selects an optimal path of travel based on the dynamic policy, thereby providing an incentive for the user to make a better travel choice and indirectly reduce congestion for other users.

In another embodiment, a step or logical operation can be provided for dynamically setting the at least one point on each path with respect to the sub-optimal path and the optimal path based on a time of day that traffic flows at an optimal level. In still another embodiment, a step or logical operation can be provided for storing the at least one point with respect to environmentally friendly options. For example, environmentally friendly options can include purchases or travel by electric, hybrid cars, etc. In other words, points can be obtained from sources other than tolled roads and parking situations.

In still another embodiment, the aforementioned image capturing unit can comprise, for example, a scanner, a GPS-enabled mobile communications device, etc. In another embodiment, the sub-optimal path can comprise, for example, a general-purpose lane, a far-away parking spot, etc. In other embodiments, the optimal path can comprise, for example, a high occupancy toll lane, a near-center parking spot or other appropriate spots.

In another embodiment, a step or logical operation can be provided for detecting the identifier by the scanner when the user approaches a toll gate in the vehicle on the high occupancy toll lane so that the at least one point is deducted from the user account. In other embodiments, steps or logical operations can be provided for capturing the identifier by the GPS-enabled mobile communications device, transmitting the identifier from the GPS-enabled mobile communications device to a point storage server, and granting the at least one point to the user if the user travels on a general purpose lane.

In another embodiment, steps or logical operations can be provided for manually entering a start and an end of a route of the travel by the user, and displaying a barcode on the GPS-enabled mobile communications device that uniquely identifies the user. In other embodiments, steps or logical operations can be provided for increasing the at least one point if the vehicle is parked in a far-away parking spot, and deducting the at least one point if the vehicle is parked in a near-center parking spot.

In another embodiment, a system for reducing traffic congestion can be implemented. Such a system can include, for example, a processor, a data bus coupled to the processor, and a computer-usable medium embodying computer program code, the computer-usable medium being coupled to the data bus, the computer program code comprising instructions executable by the processor. In some embodiments, such instructions can be configured, for example, for capturing an identifier associated with a vehicle utilizing an image capturing unit that stores and/or deducts at least one point with respect to a user account, storing the at least one point in the user account based on a dynamic policy if a user chooses a sub-optimal path of travel and a level of urgency related to the travel is low, and deducting the at least one point if the user selects an optimal path of travel based on the dynamic policy, thereby providing an incentive for the user to make a better travel choice and indirectly reduce congestion for other users.

In other embodiments, such instructions can be further configured for dynamically setting the at least one point on each path with respect to the sub-optimal path and the optimal path based on a time of day that traffic flows at an optimal level. In other embodiments, such instructions can be further configured for storing the at least one point with respect to environmentally friendly options. In other embodiments, the image capturing unit can comprise, for example, a scanner, a GPS-enabled mobile communications device, etc.

In another embodiment, the sub-optimal path can comprise, for example, at least one of the following: a general-purpose lane or a far-away parking spot. In another embodiment, the optimal path can comprise, for example, at least one of the following: a high occupancy to lane or a near-center parking spot.

In other embodiments, such instructions can be further configured for detecting the identifier by the scanner when the user approaches a toll gate in the vehicle on the high occupancy toll lane so that the at least one point is deducted from the user account. In yet other embodiments, such instructions can be further configured for: capturing the identifier by the GPS-enabled mobile communications device, transmitting the identifier from the GPS-enabled mobile communications device to a point storage server, and granting the at least one point to the user if the user travels on a general purpose lane. In other embodiments, such instructions can be further configured for manually entering a start and an end of a route of the travel by the user; and displaying a barcode on the GPS-enabled mobile communications device that uniquely identifies the user.

In still another embodiment, a processor-readable medium storing code representing instructions to cause a process for reducing traffic congestion can be provided. Such code can include code to, for example: capture an identifier associated with a vehicle utilizing an image capturing unit that stores and/or deducts at least one point with respect to a user account; store the at least one point in the user account based on a dynamic policy if a user chooses a sub-optimal path of travel and a level of urgency related to the travel is low, and deduct the at least one point if the user selects an optimal path of travel based on the dynamic policy, thereby providing an incentive for the user to make a better travel choice and indirectly reduce congestion for other users.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for reducing traffic congestion, said method comprising:
capturing an identifier associated with a vehicle utilizing an image capturing unit that stores and/or deducts at least one point with respect to a user account;
storing said at least one point in said user account based on a dynamic policy if a user chooses a sub-optimal path of travel and a level of urgency related to said travel is low; and
deducting said at least one point if said user selects an optimal path of travel based on said dynamic policy, thereby providing an incentive for said user to make a better travel choice and indirectly reduce congestion for other users.

2. The method of claim 1 further comprising dynamically setting said at least one point on each path with respect to said sub-optimal path and said optimal path based on a time of day that traffic flows at an optimal level.

3. The method of claim 1 further comprising storing said at least one point with respect to environmentally friendly options.

4. The method of claim 1 wherein said image capturing unit comprises at least one of the following: a scanner and a GPS-enabled mobile communications device.

5. The method of claim 1 wherein said sub-optimal path comprises at least one of the following: a general purpose lane and a far-away parking spot.

6. The method of claim 1 wherein said optimal path comprises at least one of the following: a high occupancy to lane and a near-center parking spot.

7. The method of claim 4 further comprising detecting said identifier by said scanner when said user approaches a toll gate in said vehicle on said high occupancy to lane so that said at least one point is deducted from said user account.

8. The method of claim 4 further comprising:
capturing said identifier by said GPS-enabled mobile communications device;
transmitting said identifier from said GPS-enabled mobile communications device to a point storage server; and
granting said at least one point with respect to said user if said user travels on a general purpose lane.

9. The method of claim 3 further comprising:
manually entering a start and an end of a route of said travel by said user; and
displaying a barcode on said GPS-enabled mobile communications device that uniquely identifies said user.

10. The method of claim 2 further comprising:
increasing said at least one point if said vehicle is parked in a far-away parking spot; and
deducting said at least one point if said vehicle is parked in a near-center parking spot.

11. A system for reducing traffic congestion, said method comprising:
a processor;
a data bus coupled to said processor; and
a computer-usable medium embodying computer program code, said computer-usable medium being coupled to said data bus, said computer program code comprising instructions executable by said processor and configured for:
capturing an identifier associated with a vehicle utilizing an image capturing unit that stores and/or deducts at least one point with respect to a user account;
storing said at least one point in said user account based on a dynamic policy if a user chooses a sub-optimal path of travel and a level of urgency related to said travel is low; and
deducting said at least one point if said user selects an optical path of travel based on said dynamic policy, thereby providing an incentive for said user to make a better travel choice and indirectly reduce congestion for other users.

12. The system of claim 11 wherein said instructions are further configured for dynamically setting said at least one point on each path with respect to said sub-optimal path and said optimal path based on a time of day that traffic flows at an optimal level.

13. The system of claim 11 wherein said instructions are further configured for storing said at least one point with respect to environmentally friendly options.

14. The system of claim 11 wherein said image capturing unit comprises at least one of the following: a scanner and a GPS-enabled mobile communications device.

15. The system of claim 11 wherein said sub-optimal path comprises at least one of the following: a general-purpose lane and a far-away parking spot.

16. The system of claim 11 wherein said optimal path comprises at least one of the following: a high occupancy toll lane and a near-center parking spot.

17. The system of claim 14 wherein said instructions are further configured for detecting said identifier by said scanner when said user approaches a toll gate in said vehicle on said high occupancy toll lane so that said at least one point is deducted from said user account.

18. The system of claim 14 wherein said instructions are further configured for:
capturing said identifier by said GPS-enabled mobile communications device;
transmitting said identifier from said GPS-enabled mobile communications device to a point storage server; and
granting said at least one point with respect to said user if said user travels on a general-purpose lane.

19. The system of claim 14 wherein said instructions are further configured for:
manually entering a start and an end of a route of said travel by said user; and
displaying a barcode on said GPS-enabled mobile communications device that uniquely identifies said user.

20. A processor-readable medium storing code representing instructions to cause a process for reducing traffic congestion, said code comprising code to:
capture an identifier associated with a vehicle utilizing an image-capturing unit that stores and/or deducts at least one point with respect to a user account;
store said at least one point in said user account based on a dynamic policy if a user chooses a sub-optimal path of travel and a level of urgency related to said travel is low; and
deduct said at least one point if said user selects an optimal path of travel based on said dynamic policy, thereby providing an incentive for said user to make a better travel choice and indirectly reduce congestion for other users.
